(19) United States
(12) Patent Application Publication
(10) Pub. No.: US 2025/0182340 A1
(43) Pub. Date: Jun. 5, 2025

(54) DISPLAY SYSTEM OF WORK MACHINE, REMOTE OPERATION SYSTEM OF WORK MACHINE, WORK MACHINE, AND DISPLAY METHOD OF WORK MACHINE

(71) Applicant: Komatsu Ltd., Tokyo (JP)

(72) Inventors: Kazuhisa Takahama, Tokyo (JP); Souichi Tsumura, Tokyo (JP)

(73) Assignee: Komatsu Ltd., Tokyo (JP)

(21) Appl. No.: 18/845,954

(22) PCT Filed: May 19, 2023
(86) PCT No.: PCT/JP2023/018757

§ 371 Date: Sep. 11, 2024

(30) Foreign Application Priority Data
May 27, 2022 (JP) 2022-086846

(51) Int. Cl. G06T 11/00; E02F 3/76; E02F 5/32; E02F 9/20

(52) U.S. Cl. CPC G06T 11/00; E02F 9/205; E02F 3/7604; E02F 5/32

(57) ABSTRACT

A display system of a work machine includes a three-dimensional data acquisition unit that acquires three-dimensional data of a work target of ripper working equipment coupled to a vehicle body of a work machine, an image data acquisition unit that acquires a work target image showing an image of the work target, a contact position calculation unit that calculates, based on the three-dimensional data, an initial position of a ripper blade edge provided in a shank of the ripper working equipment, and a moving path of a ripper point, a contact position with which the ripper point comes into contact in the work target, a contact position image generation unit that generates a contact position image showing the contact position, and a display control unit that combines the work target image and the contact position image and causes a display device to display a combined image.

### FIELD

The present disclosure relates to a display system of a work machine, a remote operation system of a work machine, a work machine, and a display method of a work machine.

### BACKGROUND

In a technical field relating to a display system of a work machine, a display system as disclosed in Patent Literature 1 is known.

### CITATION LIST

### Patent Literature

Patent Literature 1: JP 2020-197045 A

### SUMMARY

### Technical Problem

When it becomes difficult for an operator to recognize relative positions of a work machine and a work target in remote operation for the work machine, work efficiency is likely to decrease. Also, when the operator riding on the work machine operates working equipment, it is sometimes difficult to grasp the distance between the working equipment and the work target depending on the skill of the operator, and the work efficiency is likely to decrease.

An object of the present disclosure is to suppress a decrease in work efficiency.

### Solution to Problem

In order to achieve an aspect of the present invention, a display system of a work machine, comprises: a three-dimensional data acquisition unit that acquires three-dimensional data of a work target of ripper working equipment coupled to a vehicle body of a work machine; an image data acquisition unit that acquires a work target image showing an image of the work target; a contact position calculation unit that calculates, based on the three-dimensional data, an initial position of a ripper point provided in a shank of the ripper working equipment, and a moving path of the ripper point, a contact position with which the ripper point comes into contact in the work target; a contact position image generation unit that generates a contact position image showing the contact position; and a display control unit that combines the work target image and the contact position image and causes a display device to display a combined image.

### Advantageous Effects of Invention

According to the present disclosure, a decrease in work efficiency is suppressed.

### BRIEF DESCRIPTION OF DRAWINGS

FIG. 1 is a schematic diagram illustrating a remote operation system of a work machine according to a first embodiment.

FIG. 2 is a side diagram illustrating the work machine according to the first embodiment.

FIG. 3 is a rear diagram illustrating the work machine according to the first embodiment.

FIG. 4 is a block diagram illustrating the remote operation system including a display system according to the first embodiment.

FIG. 5 is a diagram for explaining a method of calculating a contact position according to the first embodiment.

FIG. 6 is a diagram for explaining the method of calculating the contact position according to the first embodiment.

FIG. 7 is a diagram illustrating an example of display data displayed on a display device according to the first embodiment.

FIG. 8 is a flowchart illustrating a method for generating three-dimensional map data according to the first embodiment.

FIG. 9 is a flowchart illustrating a display method in work of ripper working equipment according to the first embodiment.

FIG. 10 is a diagram illustrating a work target image and a contact position image displayed on the display device according to the first embodiment.

FIG. 11 is a diagram illustrating a contact position image according to a modification of the first embodiment.

FIG. 12 is a diagram illustrating a contact position image according to a modification of the first embodiment.

FIG. 13 is a diagram illustrating a contact position image according to a modification of the first embodiment.

FIG. 14 is a block diagram illustrating a remote operation system including a display system according to a second embodiment.

FIG. 15 is a diagram illustrating a work target image and a contact position image displayed on a display device according to the second embodiment.

FIG. 16 is a diagram illustrating a contact position image according to a modification of the second embodiment.

FIG. 17 is a block diagram illustrating a computer system according to an embodiment.

### DESCRIPTION OF EMBODIMENTS

An embodiment according to the present disclosure is explained below with reference to the drawings. However, the present disclosure is not limited to the embodiment. Constituent elements of the embodiment explained below can be combined as appropriate. A part of the constituent elements is sometimes not used.

In the embodiment, a positional relation among units is explained using terms “left”, “right”, “front”, “rear”, “up”, and “down”. These terms indicate relative positions or directions based on the center of a work machine 10.

### First Embodiment

A first embodiment is explained.

### <Remote Operation System>

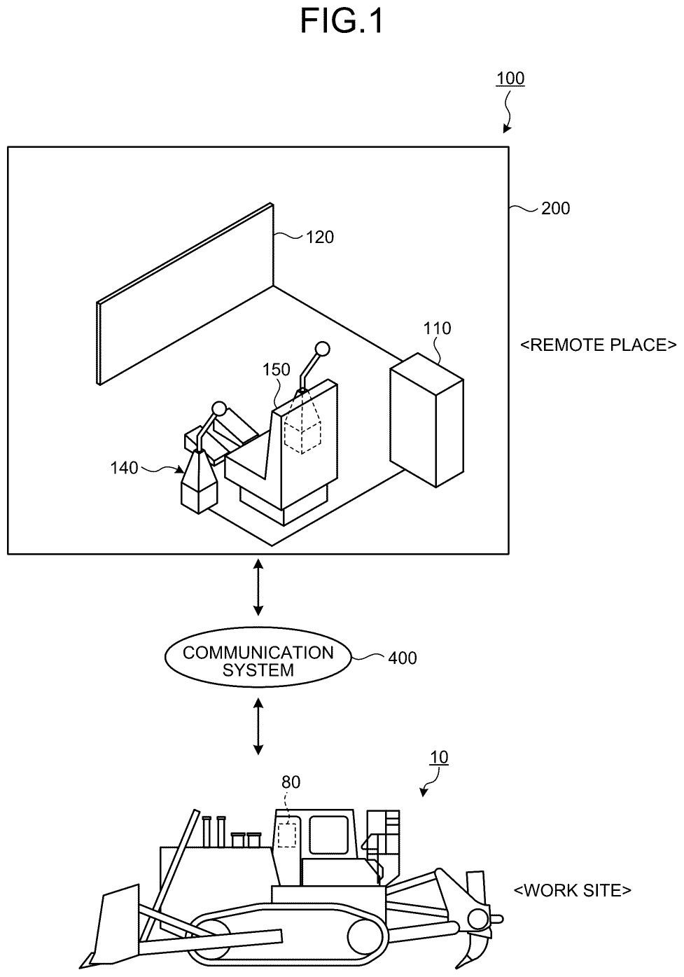

FIG. 1 is a schematic diagram illustrating a remote operation system 100 of a work machine 10 according to the present embodiment. The remote operation system 100 remotely operates the work machine 10 that works at a work site.

At least a part of the remote operation system 100 is disposed in a remote operation room 200. The remote operation room 200 is installed at a remote place away from the work site. The remote operation system 100 includes a remote operation device 140, a display device 120, and a controller 110.

The remote operation device 140 is disposed in the remote operation room 200. The remote operation device 140 is operated by an operator in the remote operation room 200. The operator performs operation for generating an operation signal for moving ripper working equipment 11 up and down and back and forth. The operator performs operation for generating an operation signal for causing a traveling body 3 to travel in the forward direction and the backward direction. The operator performs operation for generating an operation signal for causing a lift cylinder 6 to operate in order to cause a drilling blade 2 in the up-down direction. The operator performs operation for generating an operation signal for causing a tilt cylinder 1 to operate in order to change the tilt of the drilling blade. The operator can operate the remote operation device 140 in a seated state on an operation seat 150.

The display device 120 is disposed in the remote operation room 200. The display device 120 displays an image of the work site. The operator in the remote operation room 200 can visually recognize a situation of the work site via the display device 120.

The operator operates the remote operation device 140 while viewing an image of the work site displayed on the display device 120. The work machine 10 is remotely operated by the remote operation device 140.

The controller 110 is disposed in the remote operation room 200. The controller 110 includes a computer system.

The work machine 10 includes a controller 80. The controller 80 includes a computer system.

The controller 110 and the controller 80 communicate with each other via a communication system 400. Examples of the communication system 400 include the Internet, a local area network (LAN), a mobile phone communication network, and a satellite communication network. The communication system 400 may include a relay station that relays data to be communicated.

### <Work Machine>

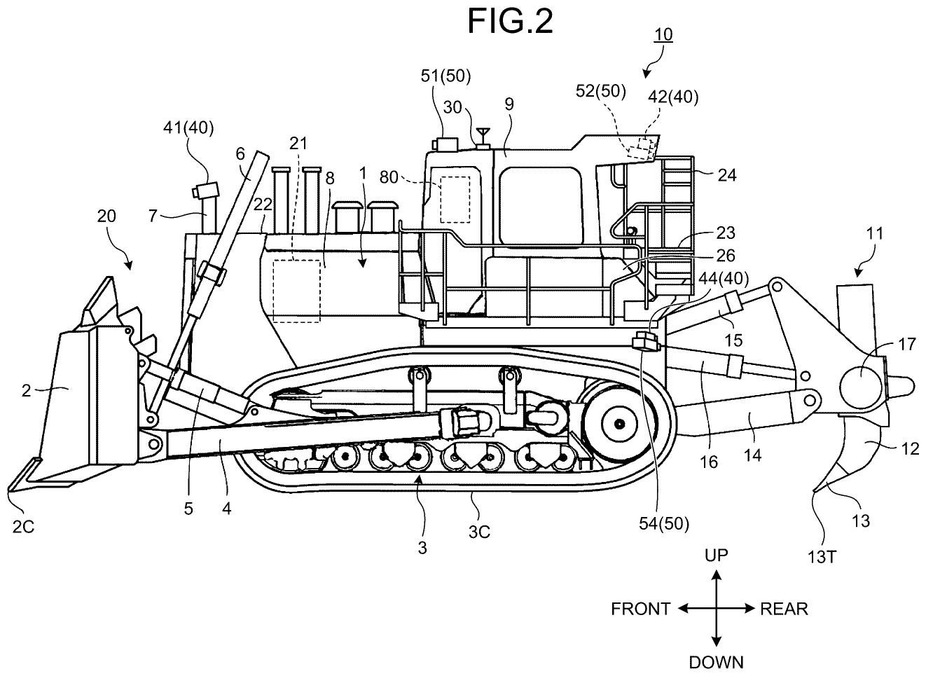

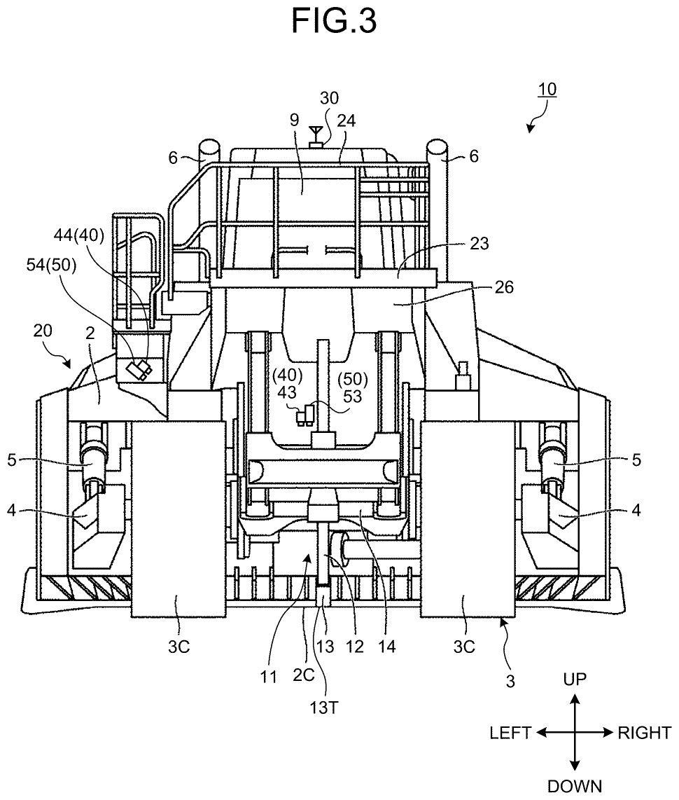

FIG. 2 is a side diagram illustrating the work machine 10 according to the present embodiment. FIG. 3 is a rear diagram illustrating the work machine 10 according to the present embodiment. In the present embodiment, the work machine 10 is a bulldozer. In the following explanation, the work machine 10 is referred to as the bulldozer 10 as appropriate.

As illustrated in FIG. 2 and FIG. 3, the bulldozer 10 includes a vehicle body 1, a drilling working equipment 20, a traveling body 3, ripper working equipment 11, a position sensor 30, a three-dimensional sensor 40, a camera 50, and a controller 80.

The vehicle body 1 includes a cab 9 and an engine compartment 8. The cab 9 is disposed in an upper part and a rear part of the vehicle body 1. The engine compartment 8 is disposed in front of the cab 9. The engine 21 is housed in the engine compartment 8. The engine 21 is a driving source of the bulldozer 10. An engine hood 22 is disposed above the engine 21. A fuel tank 26 is disposed in a rear part of the vehicle body 1. The fuel tank 26 is disposed behind the cab 9. Fuel is stored on the inside of the fuel tank 26. The fuel is supplied from the fuel tank 26 to the engine 21.

A workbench 23 is disposed above the fuel tank 26. The workbench 23 is disposed behind the cab 9. A guard rail 24 is attached to the workbench 23. A worker can carry out work on the workbench 23. Examples of the work carried out by the worker include cleaning a window of the cab 9 and replacing a filter of the fuel tank 26.

The drilling working equipment 20 carried out drilling work or ground leveling work for a work target. The drilling working equipment 20 is coupled to the vehicle body 1. At least a part of the drilling working equipment 20 is disposed in front of the vehicle body 1. The drilling working equipment 20 includes a drilling blade 2, a frame 4, a tilt cylinder 5, and a lift cylinder 6.

The drilling blade 2 is disposed in front of the vehicle body 1. The drilling blade 2 includes a cutting blade 2C. The frame 4 supports the drilling blade 2. One end portion of the frame 4 is coupled to the rear surface of the drilling blade 2 via a turning mechanism. The other end portion of the frame 4 is connected to a side part of the traveling body 3 via a turning mechanism. The frame 4 includes a first frame 4 coupled to a left part of the rear surface of the drilling blade 2 and a second frame 4 coupled to a right part of the rear surface of the drilling blade 2.

Each of the tilt cylinder 5 and the lift cylinder 6 causes the drilling blade 2 to operate. The tilt cylinder 5 is driven to cause the drilling blade 2 to perform a tilt operation. The lift cylinder 6 is driven to cause the drilling blade 2 to move up and down. One end portion of the tilt cylinder 5 is coupled to the rear surface of the drilling blade 2 via a turning mechanism. The other end portion of the tilt cylinder 5 is connected to the upper surface of the frame 4. When the tilt cylinder 5 expands and contracts, a tilt angle of the drilling blade 2 changes. One end portion of the lift cylinder 6 is coupled to the rear surface of the drilling blade 2 via a turning mechanism. An intermediate part of the lift cylinder 6 is connected to a side part of the vehicle body 1. The lift cylinder 6 expands and contracts, whereby the drilling blade 2 moves in the up-down direction.

The traveling body 3 travels while supporting the vehicle body 1. The traveling body 3 includes a pair of crawler belts 3C. The crawler belts 3C rotate, whereby the bulldozer 10 travels.

The ripper working equipment 11 carries out ripping work of cutting or crushing the work target. For example, the ripper working equipment 11 carries out rock crushing work for rocks and the like. The ripper working equipment 11 is coupled to the vehicle body 1. At least a part of the ripper working equipment 11 is disposed behind the vehicle body 1. The ripper working equipment 11 includes a shank 12, a ripper point 13, a ripper arm 14, a tilt cylinder 15, a lift cylinder 16, and a beam 17.

The shank 12 is disposed behind the vehicle body 1. The shank 12 includes the ripper point 13. The ripper point 13 is provided at the distal end portion (the lower end portion) of the shank 12 including a cutting edge position of a ripper. The ripper arm 14 supports the shank 12. The ripper arm 14 couples the vehicle body 1 and the shank 12. One end portion of the ripper arm 14 is coupled to a rear part of the vehicle body 1 via a turning mechanism. The other end portion of the ripper arm 14 is coupled to the beam 17. The beam 17 is turnably coupled to the ripper arm 14. The shank 12 is coupled to the ripper arm 14 via the beam 17.

Each of the tilt cylinder 15 and the lift cylinder 16 causes the shank 12 to operate. Each of the tilt cylinder 15 and the lift cylinder 16 is coupled to the vehicle body 1. The tilt cylinder 15 is driven to cause the shank 12 to perform a tilt operation. The lift cylinder 6 is driven to cause the shank 12 to perform an up-down operation. One end portion of the tilt cylinder 15 is coupled to the beam 17 via a turning mechanism. The other end portion of the tilt cylinder 5 is coupled to a rear part of the vehicle body 1. The tilt cylinder 15 expands and contracts, whereby a tilt angle of the shank 12 changes. The tilt cylinder 15 causes the ripper point 13 to move in the front-rear direction. One end portion of the lift cylinder 16 is coupled to the beam 17 via a turning mechanism. The other end portion of the lift cylinder 16 is coupled to a rear part of the vehicle body 1. The lift cylinder 16 expands and contracts, whereby the shank 12 moves in the up-down direction. The lift cylinder 16 causes the shank 12 including the ripper point 13 to move in the up-down direction.

The ripper working equipment 11 pierces a work target with the ripper point 13. The ripper point 13 is brought into contact with the work target during a stop of the traveling body 3 and the traveling body 3 travels in a state in which the ripper point 13 is pierced into the work target, whereby the work target is cut or crushed. During traveling of the traveling body 3, the ripper working equipment 11 is brought into contact with the target while being caused to move in the up-down and front-rear directions. The traveling body 3 travels in a state in which the work target is pierced, whereby the work target is cut or crushed.

The position sensor 30 detects the position of the bulldozer 10. The position sensor 30 detects the position of the bulldozer 10 in the global coordinate system using a global navigation satellite system (GNSS). The position sensor 30 includes a GNSS receiver provided in the vehicle body 1.

The three-dimensional sensor 40 detects the distance to the surface of a detection target. The three-dimensional sensor 40 detects three-dimensional data of the surface of the detection target by detecting a relative distance to each of a plurality of detection points on the surface of the detection target. The three-dimensional data includes point cloud data including the plurality of detection points. The three-dimensional data includes a relative distance between the three-dimensional sensor 40 and each of the plurality of detection points specified in the detection target and relative positions of the three-dimensional sensor 40 and the detection point. The three-dimensional sensor 40 detects three-dimensional data indicating a three-dimensional shape of a detection target. As the three-dimensional sensor 40, a laser sensor (LIDAR: Light Detection and Ranging) that detects a detection target by emitting laser light is exemplified. Note that the three-dimensional sensor 40 may be an infrared sensor that detects a detection target by emitting infrared light or a radar sensor (RADAR: Radio Detection and Ranging) that detects a detection target by emitting radio waves. Note that the three-dimensional sensor 40 may be a three-dimensional camera such as a stereo camera.

Three-dimensional sensor 40 detects three-dimensional data of a work site of the bulldozer 10. The three-dimensional data of the work site includes three-dimensional data of the topography (the shape of the ground surface) of the work site. The three-dimensional data of the work site includes three-dimensional data of a work target of the ripper working equipment 11.

The camera 50 captures an image of an imaging target. The camera 50 is a two-dimensional camera such as a monocular camera. The camera 50 may be a visible light camera or may be an infrared camera. The image acquired by the camera 50 may be a moving image or a still image. When the three-dimensional sensor 40 is a stereo camera, the stereo camera may be the camera 50.

The camera 50 captures an image of the work site of the bulldozer 10 and acquires an image of the work site. The image of the work site includes an image of the topography (the shape of the ground surface) of the work site. The image of the work site includes an image of a work target of the ripper working equipment 11. The image of the work site includes an image of at least a part of the ripper working equipment 11.

A plurality of three-dimensional sensors 40 are disposed in the bulldozer 10. In the present embodiment, four three-dimensional sensors 40 are disposed in the bulldozer 10. The three-dimensional sensors 40 include a first three-dimensional sensor 41, a second three-dimensional sensor 42, a third three-dimensional sensor 43, and a fourth three-dimensional sensor 44.

A plurality of cameras 50 are disposed in the bulldozer 10. In the present embodiment, four cameras 50 are disposed in the bulldozer 10. The cameras 50 include a first camera 51, a second camera 52, a third camera 53, and a fourth camera 54.

The three-dimensional sensor 41 detects a detection target in front of the vehicle body 1. The camera 51 captures an image of an imaging target in front of the vehicle body 1. A detection range of the three-dimensional sensor 41 and at least a part of an imaging range of the camera 51 overlap. The three-dimensional sensor 41 and the camera 51 may be disposed to be adjacent to each other or may be disposed at separated positions. In the present embodiment, the three-dimensional sensor 41 is supported by a support member 7 protruding upward from the engine hood 22. The camera 51 is located at the center of the vehicle width of the vehicle body 1 and is installed above the cab 9.

The three-dimensional sensor 42 detects a detection target behind the vehicle body 1. The camera 52 captures an image of an imaging target behind the vehicle body 1. A detection range of the three-dimensional sensor 42 and at least a part of an imaging range of the camera 52 overlap. The three-dimensional sensor 42 and the camera 52 are disposed to be adjacent to each other. In the present embodiment, the three-dimensional sensor 42 and the camera 52 are disposed at a rear part of the cab 9.

The three-dimensional sensor 43 detects at least a part of the ripper working equipment 11 and a work target of the ripper working equipment 11. The three-dimensional sensor 43 detects at least the ripper point 13 and a work target pierced by the ripper point 13. The camera 53 captures an image of at least a part of the ripper working equipment 11 and a work target of the ripper working equipment 11. The camera 53 captures an image of at least the ripper point 13 and the work target pierced by the ripper point 13. The three-dimensional sensor 43 and the camera 53 are disposed to be adjacent to each other. In the present embodiment, the three-dimensional sensor 43 and the camera 53 are disposed in a rear part of the vehicle body 1. The three-dimensional sensor 43 and the camera 53 are disposed at the center of the vehicle body 1 in the left-right direction.

The three-dimensional sensor 44 detects at least a part of the ripper working equipment 11 and a work target of the ripper working equipment 11. The three-dimensional sensor 44 detects at least the ripper point 13 and the work target pierced by the ripper point 13. The camera 54 captures an image of at least a part of the ripper working equipment 11 and a work target of the ripper working equipment 11. The camera 54 captures an image of at least the ripper point 13 and the work target pierced by the ripper point 13. A detection range of the three-dimensional sensor 44 and at least a part of an imaging range of the camera 54 overlap. The three-dimensional sensor 44 and the camera 54 are disposed to be adjacent to each other. The three-dimensional sensor 44 detects at least a part of the ripper working equipment 11 and the work target of the ripper working equipment 11 from a direction different from the direction of the detection by the three-dimensional sensor 43. The camera 54 detects at least a part of the ripper working equipment 11 and the work target of the ripper working equipment 11 from a direction different from the direction of the detection by the camera 53. In the present embodiment, the three-dimensional sensor 44 and the camera 54 are disposed in a rear part on the left of the vehicle body 1.

### <Display System>

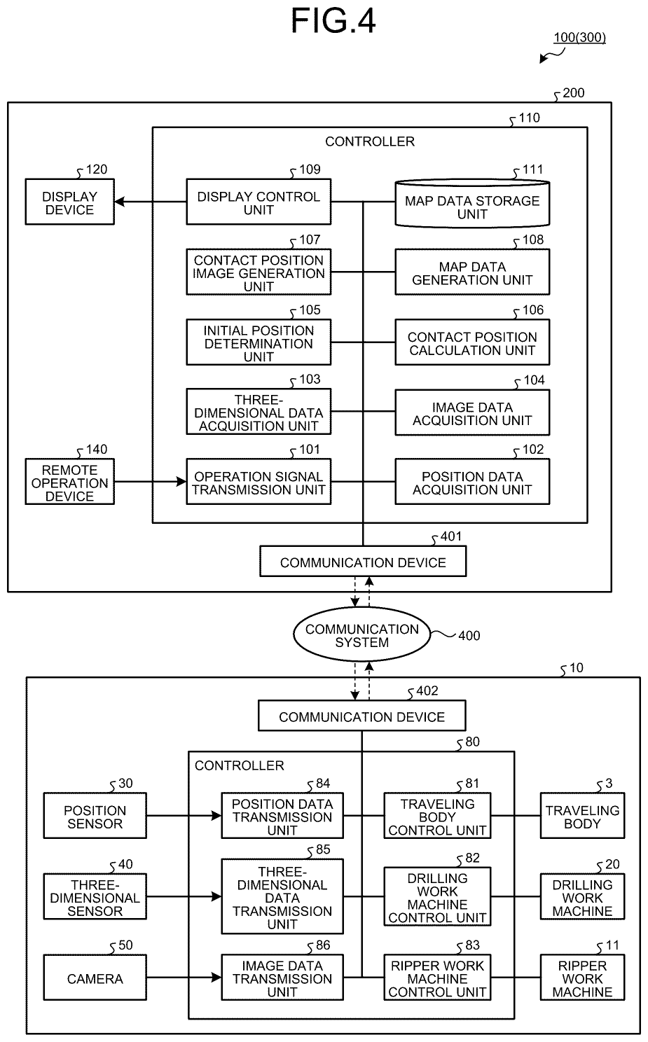

FIG. 4 is a block diagram illustrating the remote operation system 100 including the display system 300 according to the present embodiment. As illustrated in FIG. 4, the remote operation system 100 includes a communication device 401 disposed in the remote operation room 200, the controller 110 connected to the communication device 401, the remote operation device 140 connected to the controller 110, and the display device 120 connected to the controller 110. Further, the remote operation system 100 includes a communication device 402 disposed on the bulldozer 10, the controller 80 connected to the communication device 402, the position sensor 30 connected to the controller 80, the three-dimensional sensor 40 connected to the controller 80, the camera 50 connected to the controller 80, the traveling body 3 controlled by the controller 80, the drilling working equipment 20 controlled by the controller 80, and the ripper working equipment 11 controlled by the controller 80.

In the example illustrated in FIG. 4, a connection destination of the remote operation device 140 and a connection destination of the display device 120 are the common controller 110. However, the connection destinations may be different controllers. Similarly, in the controller 80 on the in-vehicle side, a controller connected to the position sensor 30, the three-dimensional sensor 40, and the camera 50 and a controller that controls the traveling body 3, the drilling working equipment 20, and the ripper working equipment 11 may be separate controllers.

The controller 80 includes a traveling body control unit 81, a drilling working equipment control unit 82, a ripper working equipment control unit 83, a position data transmission unit 84, a three-dimensional data transmission unit 85, and an image data transmission unit 86.

The traveling body control unit 81 receives an operation signal of the remote operation device 140 transmitted from the controller 110. The traveling body control unit 81 outputs, based on the operation signal of the remote operation device 140, a control signal for controlling the traveling body 3.

The drilling working equipment control unit 82 receives an operation signal of the remote operation device 140 transmitted from the controller 110. The drilling working equipment control unit 82 outputs, based on the operation signal of the remote operation device 140, a control signal for controlling the drilling working equipment 20. The control signal for controlling the drilling working equipment 20 includes a control signal for controlling the tilt cylinder 5 and the lift cylinder 6.

The ripper working equipment control unit 83 receives an operation signal of the remote operation device 140 transmitted from the controller 110. The ripper working equipment control unit 83 outputs a control signal for controlling ripper working equipment 11 based on an operation signal of remote operation device 140. The control signal for controlling ripper working equipment 11 includes a control signal for controlling the tilt cylinder 15 and the lift cylinder 16.

The position data transmission unit 84 transmits the position of the bulldozer 10 detected by one or a plurality of position sensors 30 to the controller 110.

The three-dimensional data transmission unit 85 transmits three-dimensional data detected by the three-dimensional sensor 40 to the controller 110.

The image data transmission unit 86 transmits an image captured by the camera 50 to the controller 110.

The communication device 402 communicates with the communication device 401 via the communication system 400. The communication device 402 receives an operation signal of the remote operation device 140 transmitted from the controller 110 via the communication device 401 and outputs the operation signal to the controller 80. The communication device 402 transmits the position received from the position data transmission unit 84, the three-dimensional data received from the three-dimensional data transmission unit 85, and the image received from the image data transmission unit 86 to the communication device 401 at a remote place.

The communication device 401 communicates with the communication device 402 via the communication system 400. The communication device 401 transmits an operation signal generated by the remote operation device 140 being operated to the communication device 402. The communication device 401 receives the position data, the three-dimensional data, and the image transmitted from the controller 80 via the communication device 402 and outputs the position data, the three-dimensional data, and the image to the controller 110.

The controller 110 includes an operation signal transmission unit 101, a position data acquisition unit 102, a three-dimensional data acquisition unit 103, an image data acquisition unit 104, an initial position determination unit 105, a contact position calculation unit 106, a contact position image generation unit 107, a map data generation unit 108, a display control unit 109, and a map data storage unit 111.

Note that the map data generation unit 108 may be mounted on the controller 80 on the in-vehicle side.

The operation signal transmission unit 101 transmits an operation signal for remotely operating the bulldozer 10. The remote operation device 140 is operated by the operator, whereby an operation signal for remotely operating the bulldozer 10 is generated. The operation signal transmission unit 101 transmits the operation signal of the remote operation device 140 to the controller 80.

The position data acquisition unit 102 acquires, from the controller 80, the position of the bulldozer 10 detected by the position sensor 30.

The three-dimensional data acquisition unit 103 acquires, from the controller 80, three-dimensional data of a work target of the ripper working equipment 11 detected by the three-dimensional sensor 40. The three-dimensional data may be data acquired in the past before the start of work or may be three-dimensional data acquired beforehand by a drone or the like.

The image data acquisition unit 104 acquires, from the controller 80, a work target image showing an image of a work target of the ripper working equipment 11 captured by the camera 50.

The initial position determination unit 105 determines an initial position of the ripper point 13 provided in the shank 12 of the ripper working equipment 11. The initial position of the ripper point 13 includes an initial position of a distal end portion 13T of the ripper point 13. In the present embodiment, the initial position determination unit 105 determines the initial position of the ripper point 13 based on an initial posture of the ripper working equipment 11 determined in advance. In the present embodiment, the initial posture of the ripper working equipment 11 is set to a posture at the time when the lift cylinder 16 expands the most in a movable range of the lift cylinder 16 and the tilt cylinder 15 contracts the most in a movable range of the tilt cylinder 15. That is, in the present embodiment, the initial posture of the ripper working equipment 11 is set to a posture at the time when the distal end portion 13T of the ripper point 13 is disposed at the uppermost position and the rearmost position in the movable range of the ripper point 13. In the following explanation, the initial posture of the ripper working equipment 11 is referred to as maximum tilt-back posture as appropriate.

The contact position calculation unit 106 calculates, based on the three-dimensional data of the work target, the initial position of the ripper point 13 determined by the initial position determination unit 105, and a moving path of the distal end portion 13T of the ripper point 13, a contact position with which the distal end portion 13T of the ripper point 13 comes into contact in the work target.

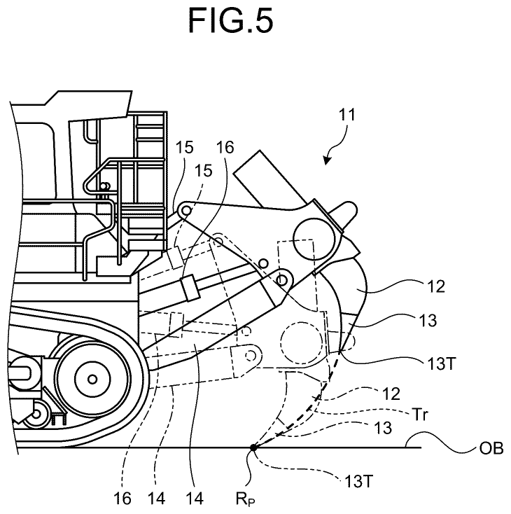

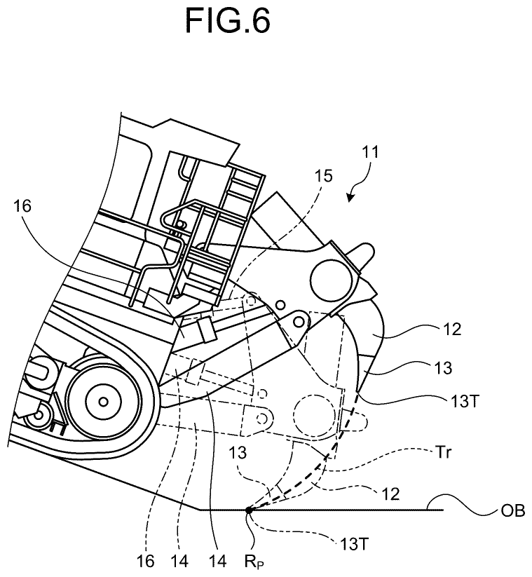

FIG. 5 and FIG. 6 are diagrams for explaining a method of calculating a contact position Rp according to the present embodiment. FIG. 5 illustrates an example in which a ground surface with which a grounding surface of the traveling body 3 comes into contact and the work target OB are disposed substantially in the same plane. FIG. 6 illustrates an example in which the work target OB is inclined with respect to the ground surface with which the grounding surface of the traveling body 3 comes into contact. In each of FIG. 5 and FIG. 6, the three-dimensional sensor 40 can detect three-dimensional data of a work target OB in a local coordinate system defined in the bulldozer 10.

When carrying out ripper work of piercing the ripper point 13 into the work target OB, after setting the ripper working equipment 11 to a maximum tilt-back posture, the operator often operates the remote operation device 140 such that the tilt cylinder 15 does not expand and contract and the lift cylinder 16 contracts. That is, an operation of the ripper working equipment 11 in the ripper work is generally standardized.

The ripper working equipment control unit 83 contracts, based on an operation signal of the remote operation device 140, the lift cylinder 16 without driving the tilt cylinder 15 from a state in which the ripper working equipment 11 is in the maximum tilt-back posture. When the lift cylinder 16 contracts from the state in which the ripper working equipment 11 is in the maximum tilt-back posture, the ripper point 13 moves downward and approaches the work target OB.

A moving path Tr of the distal end portion 13T of the ripper point 13 from the state in which the ripper working equipment 11 is in the maximum tilt-back posture until the ripper point 13 pierces the work target OB can be derived in advance based on the structure of the ripper working equipment 11. The ripper point 13 comes into contact with the work target through the moving path Tr that is a semi-arc track or an elliptical track. As explained above, the operation of the ripper working equipment 11 in the ripper work is generally standardized. In the ripper work of piercing the ripper point 13 into the work target OB, the lift cylinder 16 is driven from the state in which the ripper working equipment 11 is in the maximum tilt-back posture. Therefore, the contact position calculation unit 106 can derive the moving path Tr in advance based on the structure of the ripper working equipment 11. The contact position calculation unit 106 can calculate the contact position Rp of the distal end portion 13T of the ripper point 13 on the surface of the work target OB based on the three-dimensional data of the surface of the work target OB, the initial position of the distal end portion 13T, and the moving path Tr of the distal end portion 13T derived in advance.

The contact position image generation unit 107 generates a contact position image showing the contact position Rp calculated by the contact position calculation unit 106.

The map data generation unit 108 generates three-dimensional map data of the work site where bulldozer 10 works. The three-dimensional map data includes three-dimensional data of the work target OB. The map data generation unit 108 can generate the three-dimensional map data of the work site based on the position of the bulldozer 10 acquired by the position data acquisition unit 102 and the three-dimensional data of the work site acquired by the three-dimensional data acquisition unit 103. The three-dimensional map data generated by the map data generation unit 108 is stored in the map data storage unit 111.

In the present embodiment, the contact position calculation unit 106 calculates the contact position Rp based on the three-dimensional map data stored in the map data storage unit 111. Note that the contact position calculation unit 106 may calculate the contact position Rp based on the three-dimensional data of the work target OB acquired by the three-dimensional data acquisition unit 103.

The display control unit 109 combines the work target image and the contact position image and causes the display device 120 to display a combined image.

### <Display Example of the Display Device>

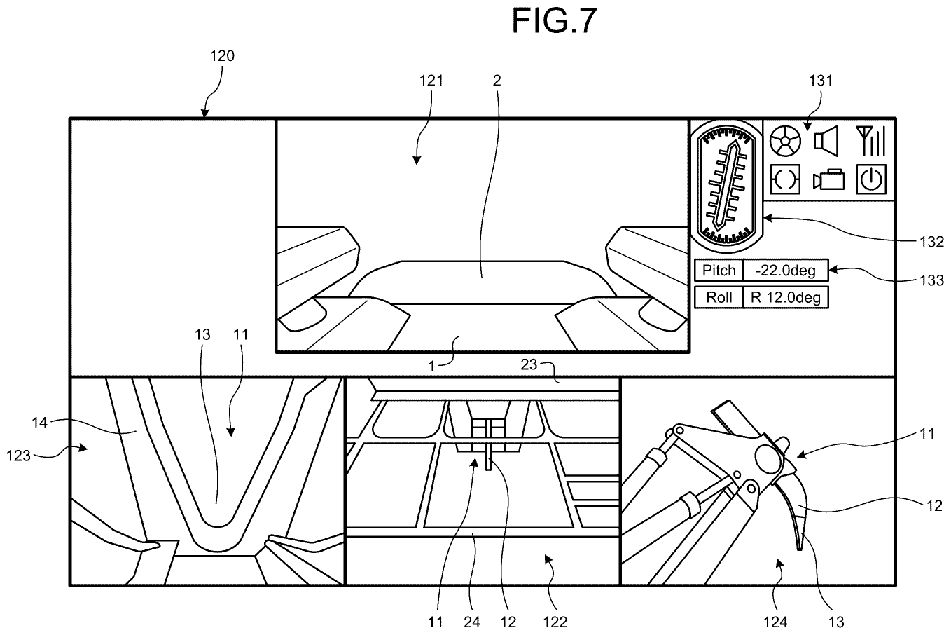

FIG. 7 is a diagram illustrating an example of display data displayed on the display device 120 according to the present embodiment.

The display control unit 109 sets a plurality of divided display screens on the display device 120. As illustrated in FIG. 7, a front display screen 121, a rear display screen 122, a first ripper display screen 123, and a second ripper display screen 124 are set as the plurality of divided display screens on the display device 120. An image captured by the camera 51 is displayed on the front display screen 121. An image captured by the camera 52 is displayed on the rear display screen 122. An image captured by the camera 53 is displayed on the first ripper display screen 123. An image captured by camera 54 is displayed on the second ripper display screen 124.

The display control unit 109 displays an icon 131, an inclinometer 132, and an inclination indicator 133 on a part of the display device 120. The inclinometer 132 and the inclination indicator 133 display a pitch angle and a roll angle of the bulldozer 10 with respect to the horizontal plane.

### <Three-Dimensional Map Data>

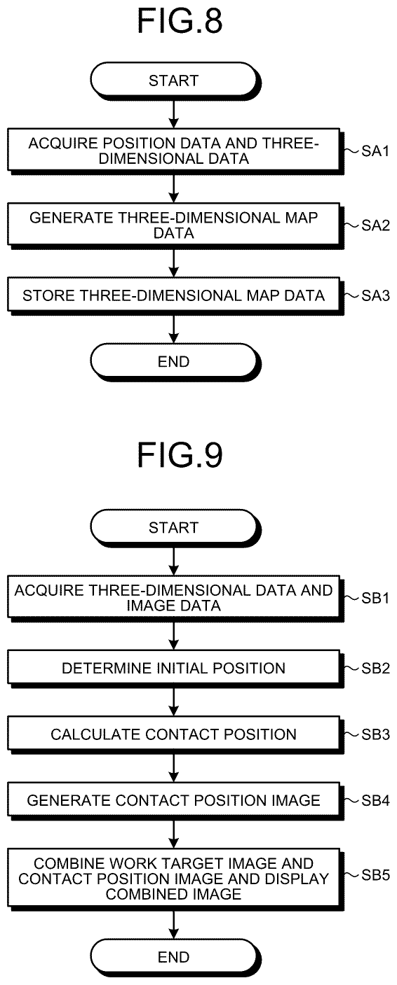

FIG. 8 is a flowchart illustrating a method of generating three-dimensional map data according to the present embodiment. In the present embodiment, three-dimensional map data of the work site is generated before the ripper work of the ripper working equipment 11 is carried out.

The bulldozer 10 travels in the work site. The position of the bulldozer 10 at the time when the bulldozer 10 travels in the work site is detected by the position sensor 30. When the bulldozer 10 travels in the work site, the three-dimensional sensor 40 detects three-dimensional data of the work site around the bulldozer 10. The three-dimensional data acquisition unit 103 acquires the three-dimensional data of the work site from the three-dimensional sensor 40. The position data acquisition unit 102 acquires, from the position sensor 30, the position of the bulldozer 10 at the time when the three-dimensional data is detected (Step SA1).

The map data generation unit 108 generates three-dimensional map data of the work site based on the position of the bulldozer 10 acquired by the position data acquisition unit 102 and the three-dimensional data of the work site acquired by the three-dimensional data acquisition unit 103 (Step SA2).

The three-dimensional data detected by the three-dimensional sensor 40 includes a relative distance between the three-dimensional sensor 40 and each of the plurality of detection points specified in the detection target and relative positions of the three-dimensional sensor 40 and the detection point. The three-dimensional data is defined in a local coordinate system of the bulldozer 10. The position of the bulldozer 10 is defined in the global coordinate system. For that reason, the map data generation unit 108 can generate, based on the position of the bulldozer 10 and the three-dimensional data of the work site acquired by the three-dimensional data acquisition unit 103, three-dimensional map data defined in the global coordinate system. The map data generation unit 108 can also generate three-dimensional map data defined in the local coordinate system by performing coordinate transformation.

The map data storage unit 111 stores the three-dimensional map data generated in Step SA2 (Step SA3).

The three-dimensional map data stored in the map data storage unit 111 may be three-dimensional map data of the entire work site or may be three-dimensional map data of a part of the work site.

### <Display Method>

FIG. 9 is a flowchart illustrating a display method in the work of the ripper working equipment 11 according to the present embodiment.

When the ripper work by the ripper working equipment 11 is started, the three-dimensional data acquisition unit 103 acquires three-dimensional data of the work target OB of the ripper working equipment 11 from the three-dimensional map data stored in the map data storage unit 111. The three-dimensional data acquisition unit 103 can extract, based on detection data of the position sensor 30 at the time when the ripper work is started, the three-dimensional data of the work target OB of the ripper working equipment 11 from the three-dimensional map data of the work site stored in the map data storage unit 111. When the ripper work is started, the image data acquisition unit 104 acquires image data from at least the camera 53. An image captured by the camera 53 includes at least an image of the ripper point 13 and an image of the work target OB of the ripper working equipment 11 (Step SB1).

The initial position determination unit 105 determines an initial position of the distal end portion 13T of the ripper point 13 based on a predetermined maximum tilt-back posture (Step SB2).

The contact position calculation unit 106 calculates, based on the three-dimensional data of the work target OB acquired in Step SB1, the initial position of the distal end portion 13T of the ripper point 13 determined in Step SB2, and the moving path Tr of the distal end portion 13T of the ripper point 13 derived in advance based on the structure of the ripper working equipment 11, the contact position Rp with which the distal end portion 13T of the ripper point 13 comes into contact in the work target OB (Step SB4).

The contact position image generation unit 107 generates a contact position image showing the contact position Rp (Step SB4).

The display control unit 109 combines the work target image and the contact position image and causes the display device 120 to displays a combined image (Step SB5).

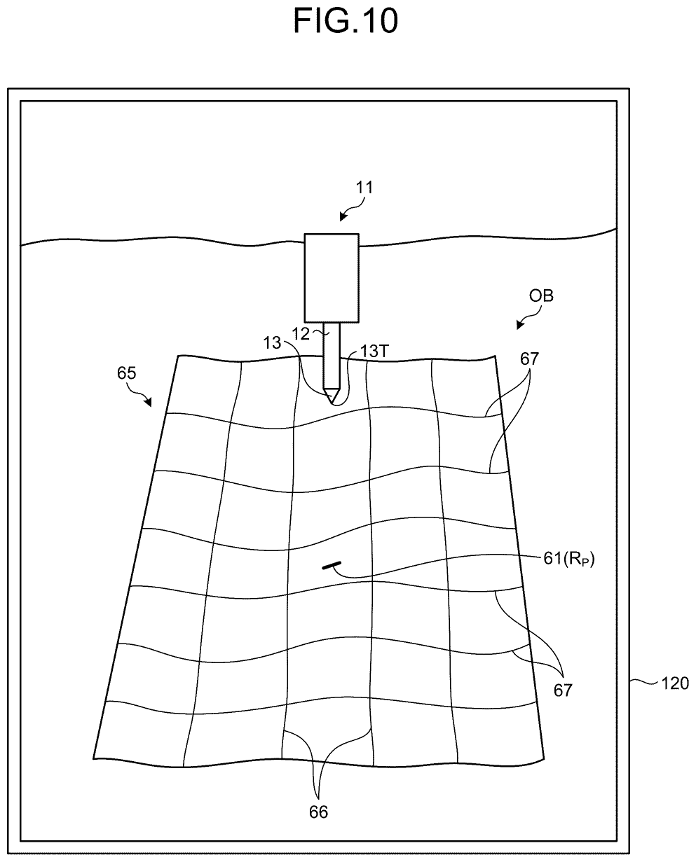

FIG. 10 is a diagram illustrating a work target image and a contact position image 61 displayed on the display device 120 according to the present embodiment. As illustrated in FIG. 10, the display control unit 109 combines working equipment image showing the ripper working equipment 11, the work target image showing the work target OB, and the contact position image 61 showing the contact position Rp and causes the display device 120 to display a combined image.

Before the ripper point 13 comes into contact with the work target OB, the display control unit 109 combines the working equipment image, the work target image, and the contact position image 61 and causes the display device 120 to display the combined image. Combining the work target image and the contact position image 61 includes superimposing the contact position image 61 on the work target image. The contact position image 61 is displayed along the surface of the work target OB.

In the present embodiment, the contact position image 61 is linearly displayed to extend in the left-right direction. The dimension of the contact position image 61 in the left-right direction may be equal to, for example, the dimension of the ripper point 13.

In the present embodiment, the display control unit 109 causes the display device 120 to display a lattice image 65 extending along the surface of the work target OB. The lattice image 65 includes a plurality of first line images 66 and a plurality of second line images 67. The plurality of first line images 66 are displayed at intervals in the left-right direction. The plurality of second line images 67 are displayed at intervals in the front-rear direction. The first line image 66 and the second line image 67 intersect with each other.

### <Effects>

As explained above, in the present embodiment, the display system 300 of the bulldozer 10 includes the three-dimensional data acquisition unit 103 that acquires three-dimensional data of the work target OB of the ripper working equipment 11 coupled to the vehicle body 1 of the bulldozer 10, the image data acquisition unit 104 that acquires a work target image showing an image of the work target OB, the contact position calculation unit 106 that calculates, based on the three-dimensional data, the initial position of the ripper point 13 provided in the shank 12 of the ripper working equipment 11, and the moving path Tr of the ripper point 13, the contact position Rp with which the ripper point 13 comes into contact in the work target OB, the contact position image generation unit 107 that generates the contact position image 61 showing the contact position Rp, and the display control unit 109 that combines the work target image and the contact position image 61 and causes the display device 120 to display a combined image.

According to the present embodiment, the contact position Rp with which the ripper point 13 comes into contact in the work target OB is calculated before the ripper point 13 comes into contact with the work target OB and the contact position image 61 showing the contact position Rp is displayed on the display device 120 in a state of being superimposed on the work target image. Therefore, the operator who remotely operates the bulldozer 10 can recognize a position where the ripper point 13 comes into contact by viewing the contact position of the contact position image 61 with respect to the work target OB before the ripper point 13 comes into contact with the work target OB. The operator can recognize relative positions of the ripper point 13 and the work target OB by looking at an interval between the ripper point 13 and the contact position of the contact position image 61. This suppresses a decrease in work efficiency.

In the present embodiment, the display system 300 includes the initial position determination unit 105 that determines an initial position of the ripper point 13. The initial position determination unit 105 determines the initial position of the ripper point 13 based on an initial posture of the ripper working equipment 11 determined in advance.

In the ripper work of piercing the ripper point 13 into the work target OB, the ripper working equipment 11 is often operated to be in the maximum tilt-back posture as the initial posture. The initial position determination unit 105 can determine the initial position of the ripper point 13 based on a maximum tilt-back posture of the ripper working equipment 11 determined in advance. For example, the initial position of the ripper point 13 is determined without providing, in bulldozer 10, a posture sensor for detecting the initial posture of the ripper working equipment 11.

In the present embodiment, the contact position calculation unit 106 calculates the contact position Rp based on the moving path Tr derived in advance.

In the ripper work, in many cases, the tilt cylinder 15 is not driven and the lift cylinder 16 is driven after the ripper working equipment 11 is operated to be in the maximum tilt-back posture. Therefore, the moving path Tr can be derived in advance based on the structure of the ripper working equipment 11. The contact position calculation unit 106 can calculate the contact position Rp based on the moving path Tr derived in advance.

In the present embodiment, the map data generation unit 108 generates three-dimensional map data of the work site. The contact position calculation unit 106 extracts three-dimensional data of the work target OB from the three-dimensional map data stored in the map data storage unit 111 and calculates the contact position Rp. Accordingly, the contact position calculation unit 106 can properly calculate the contact position Rp. In the ripper work, when the contact position Rp is calculated based on three-dimensional data transmitted from the three-dimensional sensor 40 in real time, it is likely to be difficult for the contact position calculation unit 106 to properly calculate the contact position Rp if a delay in the communication system 400 occurs. The three-dimensional map data of the work site is generated in advance before the start of the ripper work and, in the ripper work, the three-dimensional data of the work target OB is extracted from the three-dimensional map data stored in the map data storage unit 111. Accordingly, the contact position calculation unit 106 can properly calculate the contact position Rp.

Examples of a cause of the delay in the communication system 400 include a sudden change in direction of the vehicle body, inability to acquire topographic information right under the vehicle body with a sensor, and using data acquired by a front side camera or a front side sensor of the vehicle body as ripper side data when the vehicle body is moving forward.

### <Modifications>

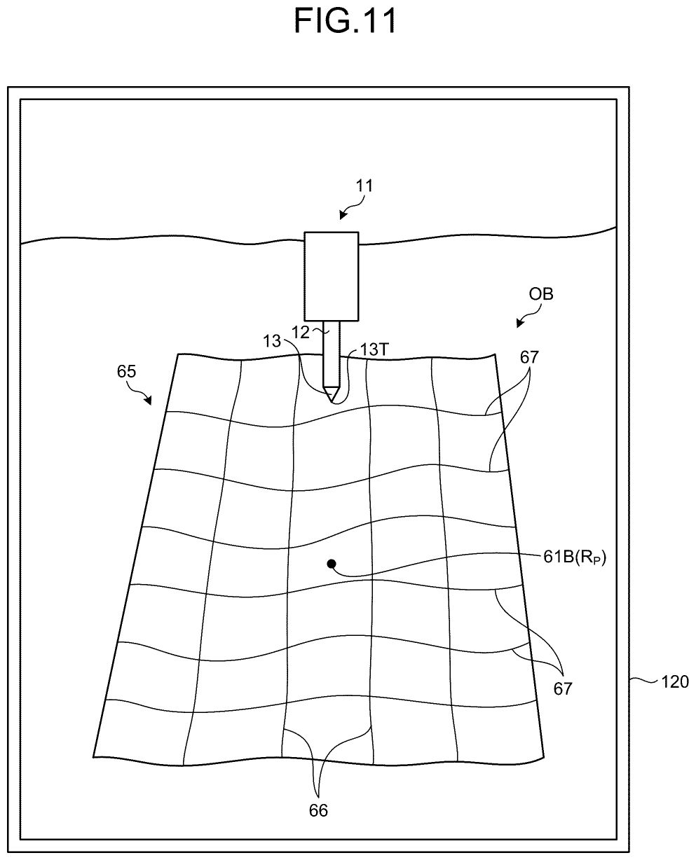

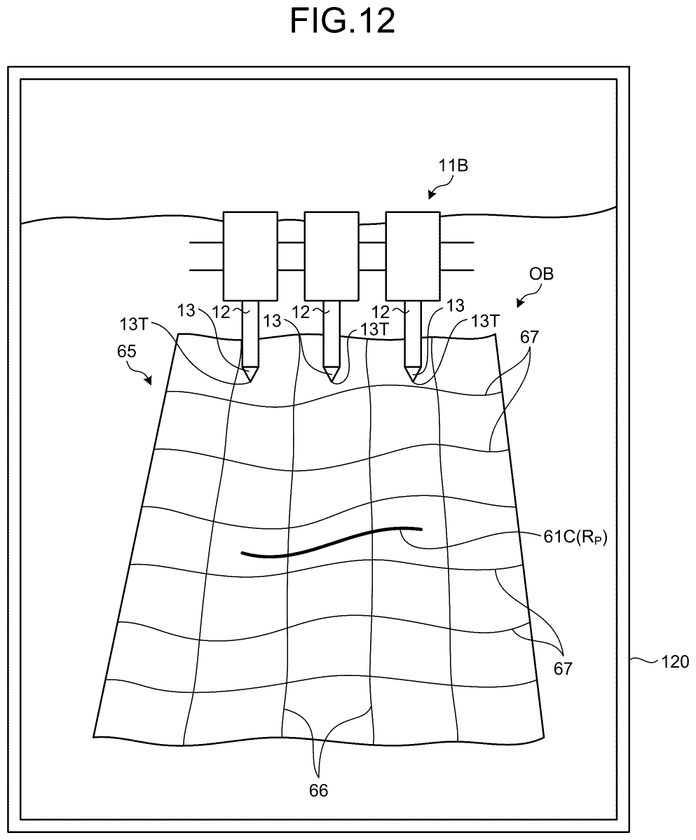

FIG. 11 is a diagram illustrating a contact position image 61B according to a modification of the present embodiment. As illustrated in FIG. 11, the contact position image 61B may be displayed in a dot to show the contact position Rp of the distal end portion 13T. A display form is not limited to the dot and may be any shape such as a circle, a cross, or an elliptical shape.

FIG. 12 is a diagram illustrating a contact position image 61C according to a modification of the present embodiment. In the example illustrated in FIG. 12, ripper working equipment 11B has a plurality of ripper points 13 disposed in the left-right direction. In the example illustrated in FIG. 12, three ripper points 13 are disposed at intervals in the left-right direction. The contact position image 61C may be linearly displayed to connect the contact positions Rp of a plurality of distal end portions 13T.

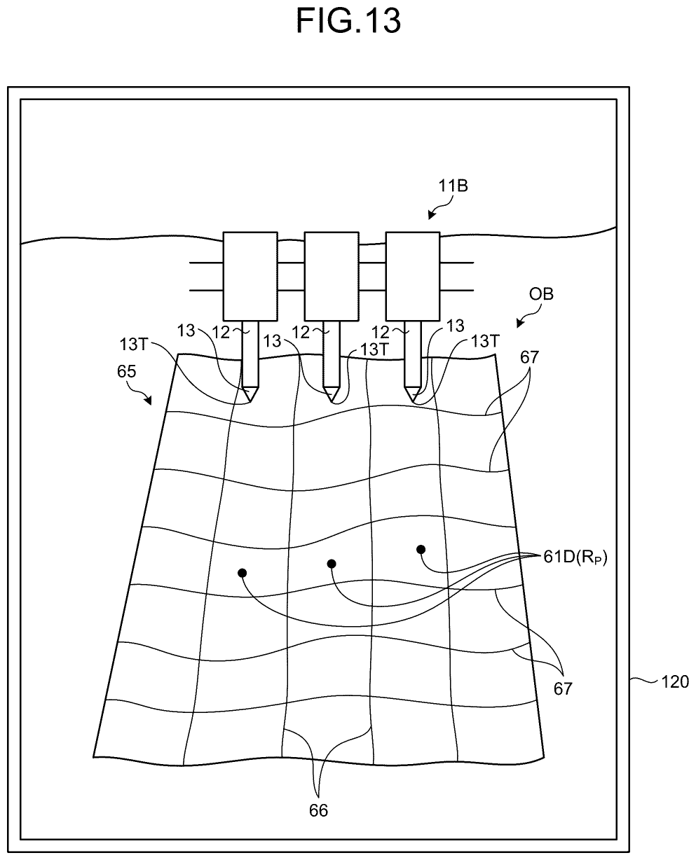

FIG. 13 is a diagram illustrating a contact position image 61D according to a modification of the present embodiment. In the example illustrated in FIG. 13, the ripper working equipment 11B has a plurality of ripper points 13 disposed in the left-right direction. In the example illustrated in FIG. 13, three ripper points 13 are disposed at intervals in the left-right direction. The contact position image 61D may be displayed in dots to respectively show the contact positions Rp of the plurality of distal end portions 13T. A display form is not limited to the dot and may be any shape such as a circle, a cross, or an elliptical shape.

### Second Embodiment

A second embodiment is explained. In the following explanation, components that are the same as or equivalent to the components in the embodiment explained above are denoted by the same reference numerals and signs, and explanation of the components is simplified or omitted.

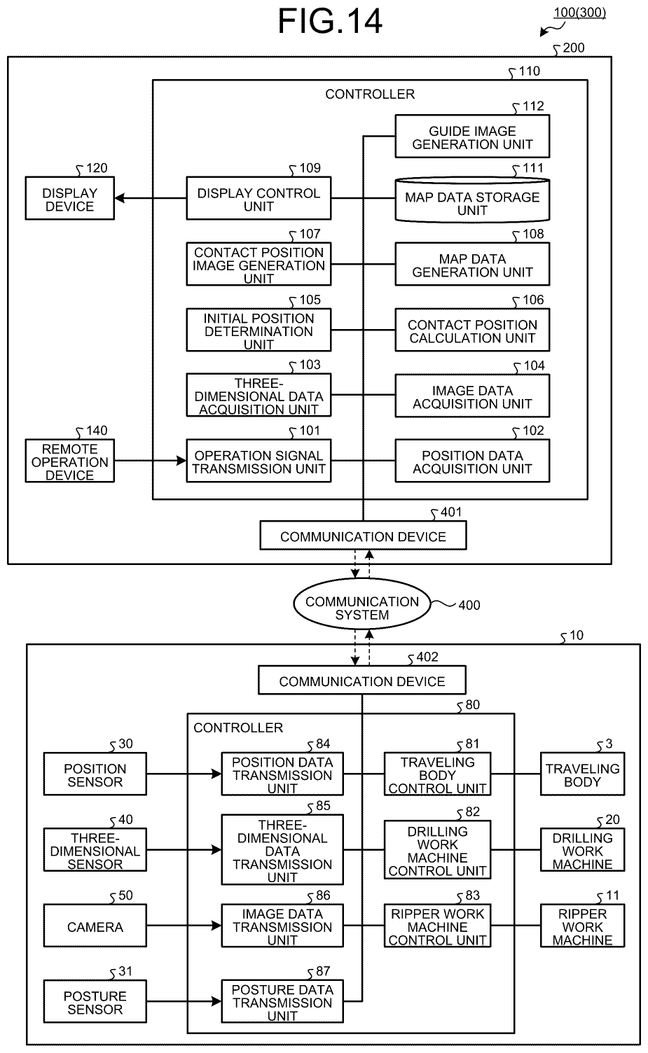

FIG. 14 is a block diagram illustrating the remote operation system 100 including the display system 300 according to the present embodiment. In the present embodiment, the bulldozer 10 is provided with a posture sensor 31. The posture sensor 31 detects the posture of the ripper working equipment 11. The posture sensor 31 can detect an initial posture of the ripper working equipment 11. As the posture sensor 31, a stroke sensor provided in each of the tilt cylinder 15 and the lift cylinder 16 is exemplified. The stroke sensor provided in the tilt cylinder 15 detects a first stroke length indicating an expansion/contraction amount of the tilt cylinder 15. The stroke sensor provided in the lift cylinder 16 detects a second stroke length indicating an expansion/contraction amount of the lift cylinder 16. Note that the posture sensor 31 may be, for example, an inertial measurement unit (IMU) provided on the shank 12.

The controller 80 includes a posture data transmission unit 87 that transmits detection data of the posture sensor 31 to the controller 110. The posture data transmission unit 87 transmits, to the controller 110, initial posture data indicating the initial posture of the ripper working equipment 11 detected by the posture sensor 31. The initial posture may be a maximum tilt-back posture or may be the ripper point 13 at the time of ripping work.

In the present embodiment, a sensor that can measure a ripper posture is mounted. The position of the ripper point 13 can be checked from the sensor. Thus, the initial posture may be the ripper point 13 during the ripping work irrespective of the maximum tilt-back posture in paragraph 0058.

In the present embodiment, the initial position determination unit 105 determines an initial position of the ripper point 13 based on detection data of the posture sensor 31 that detects the initial posture of the ripper working equipment 11. The contact position calculation unit 106 calculates, based on the three-dimensional data of the work target OB, the initial position of the ripper point 13 determined based on the detection data of the posture sensor 31, and the moving path Tr of the ripper point 13 derived from the structure of the ripper working equipment 11 and the expansion/contraction operation of the lift cylinder 16, the contact position Rp with which the ripper point 13 comes into contact in the work target OB. In the present embodiment, the controller 110 includes a guide image generation unit 112 that generates, based on the detection data of the posture sensor 31, a guide image 62 displayed between at least a part of the shank 12 and the work target OB. The guide image 62 is a line image connecting the work target and the ripper point 13. A line segment of the guide image 62 may be a line extending from the ripper point in the vertical direction with respect to the work target or may be a line that is in the tangential direction of the ripper point and is directed to the ripper point 13 and the work target surface. The display control unit 109 combines the work target image, the guide image, and the contact position image and causes the display device 120 to display a combined image.

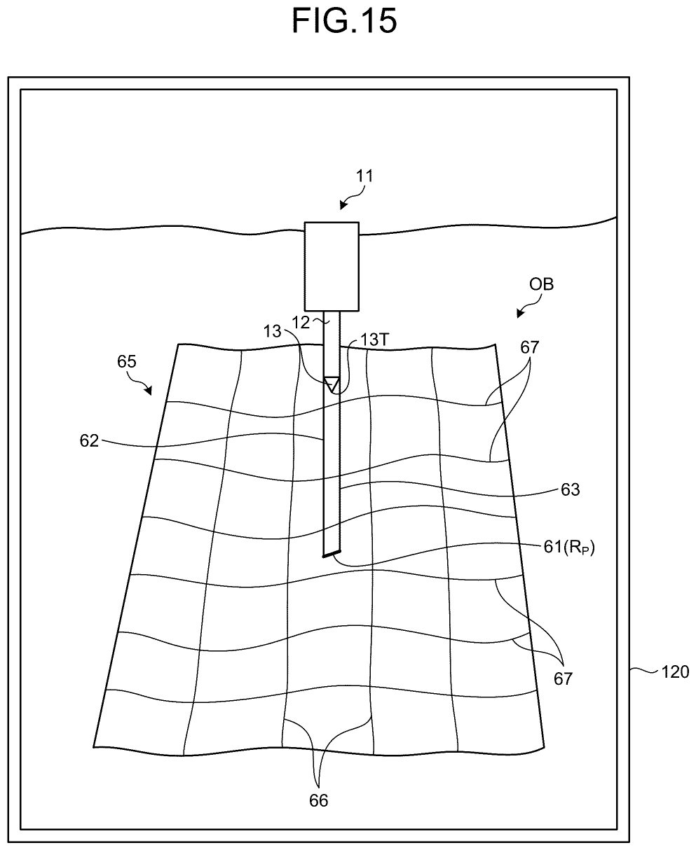

FIG. 15 is a diagram illustrating the work target image and the contact position image 61 displayed on the display device 120 according to the present embodiment. As illustrated in FIG. 15, the guide image generation unit 112 generates a first guide image 62 and a second guide image 63. Each of the guide image 62 and the guide image 63 is linear. At least a part of the guide image 62 is displayed between the right end portion of the ripper point 13 and a position with which a ripper blade edge present on the surface of the work target OB comes into contact. At least a part of the guide image 63 is displayed between the left end portion of the ripper point 13 and the position with which the ripper blade edge present on the surface of the work target OB comes into contact.

In the present embodiment, the contact position image 61 is linearly displayed to extend in the left-right direction. The dimension of the contact position image 61 in the left-right direction is equal to the dimension of the ripper point 13. The guide image 62 is displayed to connect the right end portion of the ripper point 13 and the right end portion of the contact position image 61. The guide image 63 is displayed to connect the left end portion of the ripper point 13 and the left end portion of the contact position image 61.

In the display device 120, each of the guide image 62 and the guide image 63 changes based on the position of the ripper point 13. When the ripper point 13 approaches the work target OB, each of the guide image 62 and the guide image 63 decreases in length. When the ripper point 13 is separated from the work target OB, each of the guide image 62 and the guide image 63 increases in length. In the present embodiment, the posture of the ripper working equipment 11 is detected by the posture sensor 31. The guide image generation unit 112 can calculate relative positions of the ripper point 13 and the work target OB based on the detection data of the posture sensor 31 and the three-dimensional data of the work target OB. The guide image generation unit 112 can change the length of the guide image 62 based on the position of the ripper point 13 with respect to the work target OB such that the guide image 62 continues to connect the right end portion of the ripper point 13 and the right end portion of the contact position image 61. Similarly, the guide image generation unit 112 can change the length of the guide image 63 based on the position of the ripper point 13 with respect to the work target OB such that the guide image 63 continues to connect the left end portion of the ripper point 13 and the right end portion of the contact position image 61.

### <Effects>

As explained above, in the present embodiment, the posture sensor 31 that detects an initial posture of the ripper working equipment 11 is provided. The initial position determination unit 105 determines an initial position of the ripper point 13 based on detection data of the posture sensor 31. Accordingly, even if the ripper working equipment 11 is not operated to the maximum tilt-back posture, the initial position determination unit 105 can determine the initial position of the ripper point 13 based on an initial posture of the ripper working equipment 11 detected by the posture sensor 31.

In the present embodiment, the guide image generation unit 112 generates the guide image 62 and the guide image 63 based on the detection data of the posture sensor 31. The guide image generation unit 112 can calculate relative positions of the ripper point 13 and the work target OB based on the detection data of the posture sensor 31 and the three-dimensional data of the work target OB. The guide image generation unit 112 can change the guide image 62 and the guide image 63 based on the position of the ripper point 13 with respect to the work target OB.

### <Modifications>

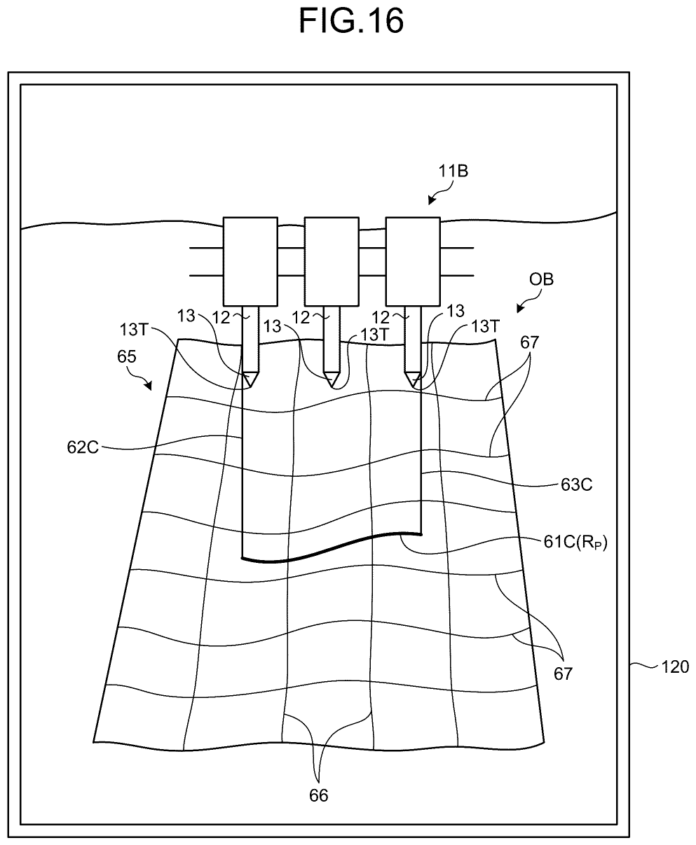

FIG. 16 is a diagram illustrating a contact position image 61C according to a modification of the present embodiment. As in the example illustrated in FIG. 12, the ripper working equipment 11B includes a plurality of ripper points 13 disposed in the left-right direction. The contact position image 61C is linearly displayed to connect the contact positions Rp of the plurality of distal end portions 13T. A guide image 62C is displayed to connect the right end portion of the ripper point 13 disposed on the rightmost side among the plurality of ripper points 13 and the right end portion of the contact position image 61C. A guide image 63C is displayed to connect the left end portion of the ripper point 13 disposed on the leftmost side among the plurality of ripper points 13 and the left end portion of the contact position image 61C.

### [Computer System]

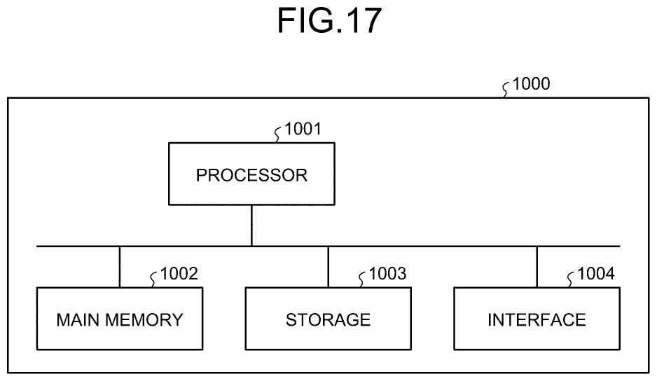

FIG. 17 is a block diagram illustrating a computer system 1000 according to an embodiment. Each of the controller 110 and the controller 80 explained above includes the computer system 1000. The computer system 1000 includes a processor 1001 such as a CPU (Central Processing Unit), a main memory 1002 including a nonvolatile memory such as a ROM (Read Only Memory) and a volatile memory such as a RAM (Random Access Memory), a storage 1003, and an interface 1004 including an input/output circuit. Functions of each of the controller 110 and the controller 80 explained above are stored in the storage 1003 as a computer program. The processor 1001 reads the computer program from the storage 1003, loads the computer program in the main memory 1002, and executes the processing explained above according to the program. Note that the computer program may be distributed to the computer system 1000 via a network.

The computer program or the computer system 1000 can execute, according to the embodiment explained above, acquiring three-dimensional data of the work target OB of the ripper working equipment 11 coupled to the vehicle body 1 of the bulldozer 10, acquiring a work target image showing an image of the work target OB, calculating, based on the three-dimensional data, an initial position of the ripper point 13 provided in the shank 12 of the ripper working equipment 11, and the moving path Tr of the ripper point 13, the contact position Rp with which the ripper point 13 comes into contact in the work target OB, generating the contact position image 61 showing the contact position Rp, and combining the work target image and the contact position image 61 and causing the display device 120 to display a combined image.

### OTHER EMBODIMENTS

In the embodiments explained above, the three-dimensional map data of the work site is generated in advance before the start of the ripper work, the three-dimensional data of the work target OB is extracted from the three-dimensional map data in the ripper work, and the contact position Rp is calculated based on the extracted three-dimensional data of the work target OB. In the calculation of the contact position Rp, the three-dimensional map data may not be used. The contact position calculation unit 106 may calculate the contact position Rp based on three-dimensional data of the work target OB detected in real time by the three-dimensional sensor 40 in the ripper work.

In the above-described embodiment, the display system 300 is applied to the remote operation system 100. The display system 300 may not be applied to the remote operation system 100 and may be mounted on the bulldozer 10. For example, the display device 120 may be disposed in the cab 9 of the bulldozer 10 and the functions of the controller 110 explained in the embodiments explained above may be provided in the controller 80 of the bulldozer 10. The bulldozer 10 may be operated by an operator riding on the cab 9.

### REFERENCE SIGNS LIST

1 VEHICLE BODY
2 DRILLING BLADE
2C CUTTING BLADE
3 TRAVELING BODY
3C CRAWLER BELT
4 FRAME
5 TILT CYLINDER
6 LIFT CYLINDER
7 SUPPORT MEMBER
8 ENGINE COMPARTMENT
9 CAB
10 BULLDOZER (WORK MACHINE)
11 RIPPER WORKING EQUIPMENT
11B RIPPER WORKING EQUIPMENT
12 SHANK
13 RIPPER POINT
13T DISTAL END PORTION
14 RIPPER ARM
15 TILT CYLINDER
16 LIFT CYLINDER
17 BEAM
20 DRILLING WORKING EQUIPMENT
21 ENGINE
22 ENGINE HOOD
23 WORKBENCH
24 GUARD RAIL
26 FUEL TANK
30 POSITION SENSOR
31 POSTURE SENSOR
40 THREE-DIMENSIONAL SENSOR
41 THREE-DIMENSIONAL SENSOR
42 THREE-DIMENSIONAL SENSOR
43 THREE-DIMENSIONAL SENSOR
44 THREE-DIMENSIONAL SENSOR
50 CAMERA
51 CAMERA
52 CAMERA
53 CAMERA
54 CAMERA
61 CONTACT POSITION IMAGE
61B CONTACT POSITION IMAGE
61C CONTACT POSITION IMAGE
62 GUIDE IMAGE
62C GUIDE IMAGE
63 GUIDE IMAGE
63C GUIDE IMAGE
65 LATTICE IMAGE
66 FIRST LINE IMAGE
67 SECOND LINE IMAGE
80 CONTROLLER
81 TRAVELING BODY CONTROL UNIT
82 DRILLING WORKING EQUIPMENT CONTROL UNIT
83 RIPPER WORKING EQUIPMENT CONTROL UNIT
84 POSITION DATA TRANSMISSION UNIT
85 THREE-DIMENSIONAL DATA TRANSMISSION UNIT
86 IMAGE DATA TRANSMISSION UNIT
87 POSTURE DATA TRANSMISSION UNIT
100 REMOTE OPERATION SYSTEM
101 OPERATION SIGNAL TRANSMISSION UNIT
102 POSITION DATA ACQUISITION UNIT
103 THREE-DIMENSIONAL DATA ACQUISITION UNIT
104 IMAGE DATA ACQUISITION UNIT
105 INITIAL POSITION DETERMINATION UNIT
106 CONTACT POSITION CALCULATION UNIT
107 CONTACT POSITION IMAGE GENERATION UNIT
108 MAP DATA GENERATION UNIT
109 DISPLAY CONTROL UNIT
110 CONTROLLER
111 MAP DATA STORAGE UNIT
112 GUIDE IMAGE GENERATION UNIT
120 DISPLAY DEVICE
121 FRONT DISPLAY SCREEN
122 REAR DISPLAY SCREEN
123 FIRST RIPPER DISPLAY SCREEN
124 SECOND RIPPER DISPLAY SCREEN
131 ICON
132 INCLINOMETER
133 INCLINATION INDICATOR
140 REMOTE OPERATION DEVICE
150 OPERATION SEAT
200 REMOTE OPERATION ROOM
300 DISPLAY SYSTEM
400 COMMUNICATION SYSTEM
401 COMMUNICATION DEVICE
402 COMMUNICATION DEVICE
1000 COMPUTER SYSTEM
1001 PROCESSOR
1002 MAIN MEMORY
1003 STORAGE
1004 INTERFACE
OB WORK TARGET
Rp CONTACT POSITION
Tr MOVING PATH

1. A display system of a work machine, comprising:
a three-dimensional data acquisition unit that acquires three-dimensional data of a work target of ripper working equipment coupled to a vehicle body of a work machine;
an image data acquisition unit that acquires a work target image showing an image of the work target;
a contact position calculation unit that calculates, based on the three-dimensional data, an initial position of a ripper point provided in a shank of the ripper working equipment, and a moving path of the ripper point, a contact position with which the ripper point comes into contact in the work target;
a contact position image generation unit that generates a contact position image showing the contact position; and
a display control unit that combines the work target image and the contact position image and causes a display device to display a combined image.

2. The display system of the work machine according to claim 1, wherein
the display control unit combines the work target image and the contact position image and causes the display device to display the combined image before the ripper point comes into contact with the work target.

3. The display system of the work machine according to claim 2, wherein
the combining the work target image and the contact position image includes superimposing the contact position image on the work target image.

4. The display system of the work machine according to claim 1, further comprising
an initial position determination unit that determines the initial position, wherein
the initial position determination unit determines the initial position based on an initial posture of the ripper working equipment determined in advance.

5. The display system of the work machine according to claim 1, further comprising
an initial position determination unit that determines the initial position, wherein
the initial position determination unit determines the initial position based on detection data of a posture sensor that detects an initial posture of the ripper working equipment.

6. The display system of the work machine according to claim 5, further comprising
a guide image generation unit that generates, based on the detection data of the posture sensor, a guide image displayed between at least a part of the shank and the work target, wherein
the display control unit combines the work target image and the guide image and causes the display device to display the combined image.

7. The display system of the work machine according to claim 1, wherein
the contact position calculation unit calculates the contact position based on the moving path derived in advance.

8. The display system of the work machine according to claim 7, wherein
the ripper working equipment includes a lift cylinder that is coupled to the vehicle body and moves a shank including the ripper point in an up-down direction, a tilt cylinder that is coupled to the vehicle body and moves the ripper point in a front-rear direction, and a ripper arm that couples the vehicle body and the shank, and
the moving path is derived in advance based on structure of the ripper working equipment.

9. The display system of the work machine according to claim 1, further comprising:
a map data generation unit that generates three-dimensional map data of a work site, where the work machine works, based on three-dimensional data of the work site, the three-dimensional data being acquired by the three-dimensional data acquisition unit; and
a map data storage unit that stores the three-dimensional map data generated by the map data generation unit, wherein
the three-dimensional map data includes three-dimensional data of the work target, and
the contact position calculation unit calculates the contact position based on the three-dimensional map data stored in the map data storage unit.

10. A remote operation system of a work machine, comprising
the display system of the work machine according to claim 1, wherein
the display device is disposed at a remote place away from a work site where the work machine works.

11. A work machine comprising
the display system of the work machine according to claim 1.

12. A display method of a work machine, comprising:
acquiring three-dimensional data of a work target of ripper working equipment coupled to a vehicle body of the work machine;
acquiring a work target image showing an image of the work target;
calculating, based on the three-dimensional data, an initial position of a ripper point provided in a shank of the ripper working equipment, and a moving path of the ripper point, a contact position with which the ripper point comes into contact in the work target;
generating a contact position image showing the contact position; and
combining the work target image and the contact position image and causing a display device to display a combined image.
